(19) United States
(12) Patent Application Publication
(10) Pub. No.: US 2025/0110214 A1
(43) Pub. Date: Apr. 3, 2025

(54) COORDINATE TRANSFORMATION CIRCUIT AND METHOD

(71) Applicant: SUTENG INNOVATION TECHNOLOGY CO., LTD., Shenzhen (CN)

(72) Inventors: Yuqi LIU, Shenzhen (CN); Yan SONG, Shenzhen (CN)

(73) Assignee: SUTENG INNOVATION TECHNOLOGY CO., LTD., Shenzhen (CN)

(21) Appl. No.: 18/784,945

(22) Filed: Jul. 26, 2024

(30) Foreign Application Priority Data
Sep. 28, 2023 (CN) 202311291317.0

(51) Int. Cl. G01S 7/48; G01S 7/481; G01S 17/42

(52) U.S. Cl. CPC G01S 7/4808; G01S 7/4817; G01S 17/42

(57) ABSTRACT

This application provides a coordinate transformation circuit and method, applied in the field of LiDAR technology. The circuit includes at least one coordinate transformation module, where the coordinate transformation module includes a control module and a data processing module. The control module is connected to an optical detection module, and the data processing module is connected to the control module. The optical detection module is used to obtain the scanning coordinates and detection distance of the detection point during operation. The control module is used to receive an operation trigger signal and the scanning coordinates and detection distance of the detection point sent by the optical detection module. The control module sends the scanning coordinates and detection distance to the data processing module and controls the data processing module to determine the radar coordinates of the detection point.

### CROSS-REFERENCE TO RELATED APPLICATION

The present application claims the benefit of priority to Chinese Patent Application No. 202311291317.0, filed on Sep. 28, 2023, which is hereby incorporated by reference in its entirety.

### TECHNICAL FIELD

This application pertains to the field of LiDAR technology, and more specifically, to a coordinate transformation circuit and method in the field of LiDAR technology.

### TECHNICAL BACKGROUND

A LiDAR, due to its high resolution and minimal interference from environmental factors, has important applications in fields such as autonomous driving and robotics. It is generally used for distance measurement of targets and can be used to detect reflection information such as the reflectivity of targets.

Laser achieves two-dimensional scanning through scanning devices, the acquired raw point cloud data is in the coordinate system of the scanning device and needs to be further converted into the radar coordinate system for subsequent point cloud data processing and application. Due to the large amount of raw point cloud data, implementing coordinate transformation through software requires substantial computing resources, imposes high computational power demands on the processor, and affects point cloud output latency.

### SUMMARY

Embodiments of this application provide a coordinate transformation circuit and method that can convert scanning coordinates to radar coordinates through hardware modules, reducing the occupation of processing resources by coordinate transformation, lowering the computational power requirements of the processor, and effectively avoiding point cloud output latency.

In one aspect, a coordinate transformation circuit is provided, including at least one coordinate transformation module, where the coordinate transformation module includes a control module and a data processing module; the control module is connected to an optical detection module, and the data processing module is connected to the control module. The optical detection module is used to obtain the scanning coordinates and detection distance of the detection point during operation. The control module is used to receive an operation trigger signal, the scanning coordinates and detection distance of the detection point sent by the optical detection module. Upon receiving the operation trigger signal, the control module sends the scanning coordinates and detection distance to the data processing module and controls the data processing module to determine the radar coordinates of the detection point, based on the scanning coordinates and detection distance.

The coordinate transformation circuit includes multiple coordinate transformation modules, where a quantity of coordinate transformation modules is not less than a quantity of detection channels of the LiDAR. Each detection channel corresponds to at least one coordinate transformation module. For a coordinate transformation module, it includes a control module and a data processing module. The control module is connected to the optical detection module, and the data processing module is connected to the control module. The optical detection module is used to obtain the scanning coordinates and detection distance of the detection point of the detection channel corresponding to the coordinate transformation module during the operation of the LiDAR. The control module is used to receive the operation trigger signal and, upon receiving it, to obtain the scanning coordinates and detection distance of the detection point of the corresponding detection channel and send them to the data processing module. The control module controls the data processing module to determine the radar coordinates of the detection point based on the scanning coordinates and detection distance. The coordinate transformation algorithm is embedded into the data processing module, converting the scanning coordinates of the detection point to radar coordinates through hardware modules, reducing the occupation of processing resources by coordinate transformation and lowering the computational power requirements of the processor. Additionally, the coordinate transformation circuit can perform real-time conversion of the scanning coordinates of the detection point, obtaining the radar coordinates of the detection point, making the coordinate data received by subsequent modules or software the radar coordinates of the detection point, effectively avoiding point cloud output latency.

In an embodiment, the data processing module includes a high-level operation unit, a basic operation unit, and a first memory; the high-level operation unit is connected to the control module, the basic operation unit, and the first memory, the basic operation unit is connected to the control module and the first memory, and the first memory is connected to the control module; the control module controls the high-level operation unit to perform at least one of matrix multiplication, trigonometric function operation, complex number operation, exponentiation, square root operation, or logarithmic operation, and controls the basic operation unit to perform addition operation and subtraction operation; and the first memory is used to store an intermediate value obtained by the high-level operation unit and the basic operation unit.

The high-level operation unit performs complex mathematical and logical operations such as matrix multiplication, trigonometric function operation, complex number operation, exponentiation, square root operation, or logarithmic operation, and the basic operation unit performs basic addition and subtraction operations. The basic operation unit is connected to the high-level operation unit, achieving the collaboration of basic and complex operations, meeting the computational requirements of coordinate transformation. The first memory stores the intermediate values obtained by the high-level operation unit and the basic operation unit, avoiding repeated calculations, allowing multiple operations to share data, further optimizing the coordinate transformation process. Additionally, the control module dynamically adjusts the execution sequence of the high-level operation unit and the basic operation unit based on the coordinate transformation requirements from scanning coordinates to radar coordinates, maximizing the computational efficiency of the data processing module.

In some possible implementations, the high-level operation unit includes a selector and at least one first high-level operation subunit; the first high-level operation subunit is connected to the control module and the selector, the selector is connected to the control module and the basic operation unit; the first high-level operation subunit performs matrix multiplication on at least one of the scanning coordinates, detection distance, and intermediate values of the detection point, obtaining an operation result; and the selector determines the target first high-level operation subunit among the at least one first high-level operation subunit and outputs the operation result of the target first high-level operation subunit, based on the selection instruction from the control module.

Based on the different dimensions of matrix multiplication involved in the scanning coordinates, detection distance, and intermediate values of the detection point in the coordinate transformation process, multiple first high-level operation subunits are configured. Each first high-level operation subunit performs matrix multiplication of different dimensions in the coordinate transformation process, achieving precise calculation of matrix multiplication of different dimensions, ensuring the accuracy of coordinate transformation. Each first high-level operation subunit has independent input and output and can be configured based on the actual operation requirements in the coordinate transformation process to meet different coordinate transformation requirements. Additionally, since each first high-level operation subunit handles operations of specific dimensions, a quantity of first high-level operation subunits can be flexibly increased or decreased as needed to meet coordinate transformation tasks of different scales or complexities.

In some possible implementations, the high-level operation unit also includes at least one second high-level operation subunit; the second high-level operation subunit is connected to the control module and the first memory; and the second high-level operation subunit performs at least one of the trigonometric function operation, complex number operation, exponentiation, square root operation, or logarithmic operation on at least one of the scanning coordinates, detection distance, and intermediate values. Each second high-level operation subunit performs different operations.

Based on the types of operations involved in the coordinate transformation process, such as trigonometric function operation, complex number operation, exponentiation, square root operation, or logarithmic operation, multiple second high-level operation subunits are configured to perform different types of operations, meeting the diverse high-level operation requirements in the coordinate transformation process. Each second high-level operation subunit specifically performs a certain type of high-level operation, ensuring the accuracy and efficiency of calculations. Configuring multiple second high-level operation subunits provides diversified high-level operation support, achieving parallel computation acceleration and flexible configuration expansion to meet the various types of high-level operation requirements in the coordinate transformation process.

In some possible implementations, the circuit also includes a second memory connected to the control module, and the second memory stores a look-up table that includes pre-stored transformation parameters; and the control module obtains the look-up table from the second memory, and controls the execution of the high-level operation unit and the basic operation unit based on the transformation parameters in the look-up table.

The coordinate transformation circuit includes a second memory that stores a look-up table containing pre-stored transformation parameters. The control module can obtain the look-up table from the second memory and control the execution of the high-level operation unit and the basic operation unit based on the transformation parameters in the look-up table, allowing the coordinate transformation circuit to dynamically select suitable transformation parameters based on the scanning coordinate range of the detection point. This effectively improves the accuracy and efficiency of coordinate transformation and allows for updating and configuring the transformation parameters based on the coordinate transformation requirements, adapting to different scanning coordinate ranges and requirements, and having a wide range of applications.

In some possible implementations, when a quantity of coordinate transformation modules is multiple, the coordinate transformation circuit also includes an arbitrator; the arbitrator is connected to the control module of each coordinate transformation module and the second memory; and when at least two control modules of the coordinate transformation modules simultaneously request to obtain the look-up table, the arbitrator prioritizes the requests from at least two coordinate transformation modules.

In an embodiment, when a quantity of coordinate transformation modules is multiple, introducing an arbitrator to handle the request conflicts of multiple coordinate transformation modules ensures the stability and reliability of the coordinate transformation circuit during concurrent access in multi-tasking scenarios. The priority decision algorithm of the arbitrator can be designed according to specific needs to meet the flexible requirements for the request order in different application scenarios.

In another aspect, a coordinate transformation method is provided, including:
receiving an operation trigger signal, and obtaining the scanning coordinates and detection distance of the detection point;
sending the scanning coordinates and detection distance to the data processing module; and
determining the radar coordinates of the detection point based on the scanning coordinates and detection distance.

In some possible implementations, determining the radar coordinates of the detection point based on the scanning coordinates and detection distance includes:
performing a trigonometric function operation on the scanning coordinates, to obtain the trigonometric function value corresponding to the scanning coordinates; and
determining the radar coordinates of the detection point based on the scanning coordinates, trigonometric function value, and detection distance.

In some possible implementations, before performing the trigonometric function operation on the scanning coordinates to obtain the trigonometric function value corresponding to the scanning coordinates, it includes: correcting the scanning coordinates to obtain the corrected scanning coordinates.

In some possible implementations, performing the trigonometric function operation on the scanning coordinates to obtain the trigonometric function value corresponding to the scanning coordinates includes: obtaining the look-up table that includes pre-stored transformation parameters; and determining the trigonometric function value corresponding to the scanning coordinates based on the transformation parameters.

In a third aspect, a LiDAR is provided, comprising the coordinate transformation circuit in the above-mentioned first aspect or any possible implementation of the first aspect.

### BRIEF DESCRIPTION OF DRAWINGS

FIG. 1 is a schematic diagram of the system architecture of LiDAR, according to some embodiments;

FIG. 2 is a circuit schematic diagram of the coordinate transformation circuit and optical detection module, according to some embodiments;

FIG. 3 is a circuit schematic diagram of the coordinate transformation module, according to some embodiments;

FIG. 4 is a schematic diagram of the scanning coordinate system, according to some embodiments;

FIG. 5 is a schematic diagram of the radar coordinate system, according to some embodiments;

FIG. 6 is a circuit schematic diagram of the coordinate transformation module, arbitrator, and second memory, according to some embodiments;

FIG. 7 is an interaction timing diagram of the internal coordinate transformation module, according to some embodiments;

FIG. 8 is a request-response timing diagram of the arbitrator for multiple coordinate transformation modules, according to some embodiments; and

FIG. 9 is a schematic flow chart of the coordinate transformation method, according to some embodiments.

### DETAILED DESCRIPTION

The following will describe the technical solutions in this application in conjunction with the accompanying drawings. In the description of the embodiments of this application, unless otherwise specified, the symbol “/” means “or”, for example, A/B can mean A or B. The term “and/or” is merely a descriptive association of associated objects, indicating that there may be three relationships, for example, A and/or B can mean the presence of A alone, the simultaneous presence of A and B, or the presence of B alone. In the description of the embodiments of this application, “multiple” means two or more.

Hereinafter, the terms “first” and “second” are only for descriptive purposes and should not be understood as indicating relative importance or implying a specific number of the indicated technical features. Thus, features defined with “first” and “second” may explicitly or implicitly include one or more of these features.

The terminology involved in one or more embodiments of this specification is explained.

LiDAR: A radar system that detects target position, speed, and other characteristic quantities by emitting laser beams. Its working principle is: emitting a detection signal (emitting laser) to the target object, receiving the echo signal reflected from the target object (echo laser electrical signal), and analyzing the echo signal to obtain the flight time of the echo laser. Based on the emitting direction of the emitting laser and the flight time of the echo laser, the information of the target object is obtained, such as the target distance, azimuth, height, speed, attitude, and even shape parameters of the target object.

Embodiments of this application provide a coordinate transformation circuit that can be set between the optical detection module of LiDAR and the signal processing equipment. During the operation of LiDAR, the optical detection module obtains the scanning coordinates and detection distance of the detection point, and sends them to the coordinate transformation circuit. The coordinate transformation circuit converts the scanning coordinates based on the scanning coordinates and detection distance to obtain the radar coordinates of the detection point. The coordinate transformation circuit provided by embodiments of this application can embed the coordinate transformation algorithm into the data processing module, converting the scanning coordinates to radar coordinates through hardware modules, and reducing the processing resource occupation of the processor and lowering the computational power requirements. Additionally, the coordinate transformation circuit can perform real-time conversion of the scanning coordinates of the detection point, making the coordinate data received by subsequent modules or software the radar coordinates directly, and facilitating the direct processing of point cloud data and effectively avoiding point cloud output delay.

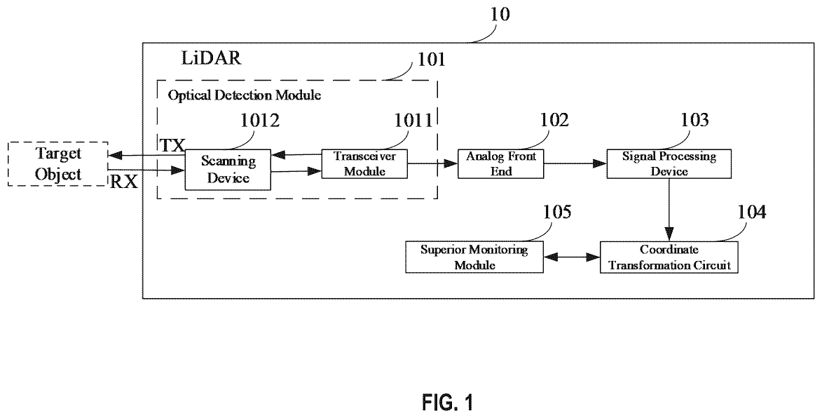

As shown in FIG. 1, FIG. 1 is a schematic diagram of the system architecture of LiDAR. In an embodiment, the LiDAR 10 includes an optical detection module 101, an analog front end (AFE) 102, a signal processing device 103, a coordinate transformation circuit 104, a communication module, and a power module, etc. The optical detection module includes a transceiver module 1011 and a scanning device 1012.

The transceiver module 1011 includes an emitting module (optical source module) and a receiving module (photoelectric detection module). The emitting module is used to emit detection signals (emitting laser) to the scanning device 1012. The emitting module includes a laser and an optical lens group, where the laser is used to emit the emitting laser, and the optical lens group is used to shape the emitting laser, such as collimation, beam splitting, etc. The receiving module is used to receive the detection signals emitted by the emitting module and reflected by the target object (echo laser), converting the echo laser into an echo signal. The receiving module includes a receiver and a receiving lens group, where the receiver converts the echo laser into an echo signal, and the receiving lens group shapes the echo signal optically before directing it to the receiver, such as focusing and collimation.

The transceiver module 1011 sends the detection signal (TX) generated by the emitting module to the scanning device 1012. The scanning device 1012 reflects the detection signal (TX) to the target object and also receives and deflects the echo signal (RX) reflected from the target object to the transceiver module 1011. The transceiver module 1011 also receives the echo signal (RX) reflected by the target object.

The scanning device 1012 is used to receive the detection signal (TX) sent by the transceiver module 1011 and reflect the detection signal (TX) to the target object. It receives and deflects the echo signal (RX) reflected from the target object back to the transceiver module 1011. The scanning device 1012 can include one or more of a multi-faceted rotating mirror, a galvanometer, and a rotating reflector.

The multi-faceted rotating mirror is usually prismatic, with multiple sides arranged around an axis, where the sides are used to reflect detection signals and echo signals. The multi-faceted rotating mirror can rotate around its axis, making the reflection surface achieve the reflection of detection signals and echo signals. The multi-faceted rotating mirror is used to achieve one-dimensional scanning. For example, the axis of the multi-faceted rotating mirror can be set vertically, with the reflection surface rotating around the axis to achieve horizontal scanning of the detection signals and echo signals.

In some embodiments, the galvanometer has one rotating axis, performing one-dimensional scanning of detection signals and echo signals by rotating around the rotating axis. This galvanometer is a one-dimensional galvanometer and can be combined with the multi-faceted rotating mirror to achieve two-dimensional scanning of detection signals and echo signals. For example, the multi-faceted rotating mirror performs horizontal scanning, and the one-dimensional galvanometer performs vertical scanning of detection signals and echo signals. In other embodiments, two one-dimensional galvanometers can be combined to achieve two-dimensional scanning of detection signals and echo signals. For example, one one-dimensional galvanometer performs horizontal scanning, and the other one-dimensional galvanometer performs vertical scanning. In other embodiments, the galvanometer has two rotating axes, the fast axis and the slow axis, which are perpendicular to each other. The galvanometer can rotate around both the fast and slow axes, achieving two-dimensional scanning. For example, the fast axis is usually used for horizontal scanning, and the slow axis is usually used for vertical scanning.

The analog front end (AFE) 102 processes the echo signals (RX) given by the transceiver module 1011, obtaining the processed echo signals. The main functions of the analog front end include signal amplification, signal shaping, etc.

The signal processing device 103 can include a processor and at least an analog-to-digital converter (ADC), a time-to-digital converter (TDC), and a memory. The processor can have built-in storage space and analog-to-digital conversion functions to replace the ADC and memory. The ADC and TDC convert the processed echo signals output by the analog front end 102 into digital signals. The processor samples the digital signals output by the ADC, obtaining the reception time of the echo signal (RX) and determining the detection distance of the detection point based on the reception time of the echo signal (RX). The processor determines the scanning coordinates of the detection point based on the emitting direction of the emitting laser, and transmits the scanning coordinates and detection distance of the detection point to the coordinate transformation circuit 104.

In an embodiment, the processor can be a central processing unit (CPU), other general-purpose processors, digital signal processors (DSP), application-specific integrated circuits (ASIC), field-programmable gate arrays (FPGA), or other programmable logic devices, discrete gate or transistor logic devices, discrete hardware components, etc. The general-purpose processor can be a microprocessor or any conventional processor.

In an embodiment, the transceiver module 1011 emits detection signal (TX) to the scanning device 1012. The scanning device 1012 reflects the detection signal (TX) to the target object and returns the echo signal (RX) to the transceiver module 1011. The transceiver module 1011 receives the echo signal (RX). The transceiver module 1011 sends the echo signal (RX) to the analog front end 102, which processes the echo signal (RX) to obtain processed echo signal and sends it to the signal processing device 103. The signal processing device converts the processed echo signal into a digital signal, samples the digital signal to obtain a reception time of the echo signal (RX), and determines the detection distance of the detection point based on the reception time of the echo signal (RX). The signal processing device also determines the scanning coordinates of the detection point based on the emitting direction of the detection signal (TX) and inputs the scanning coordinates and detection distance of the detection point to the coordinate transformation circuit 104, which converts the scanning coordinates of the detection point to radar coordinates.

In an embodiment, besides the aforementioned method of obtaining the detection distance and scanning coordinates of the detection point, other methods can be used to obtain the detection distance and scanning coordinates of the detection point. The obtained detection distance and scanning coordinates of the detection point are input into the coordinate transformation circuit 104, where the coordinate transformation circuit 104 converts the scanning coordinates of the detection point to radar coordinates.

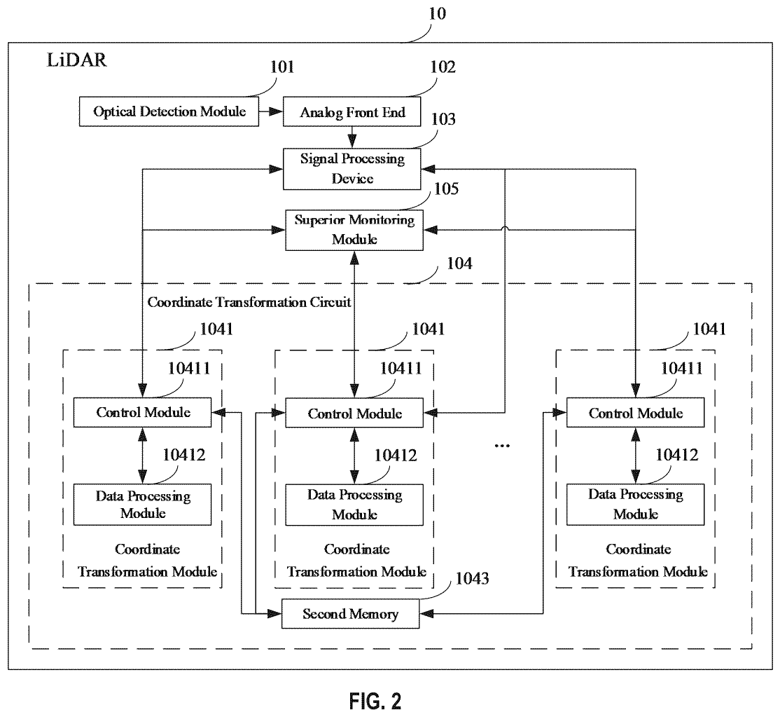

As shown in FIG. 2, FIG. 2 is a schematic circuit diagram of the coordinate transformation circuit provided by an embodiment. The coordinate transformation circuit 104 includes at least one coordinate transformation module 1041, where the coordinate transformation module 1041 comprises a control module 10411 and a data processing module 10412.

In an embodiment, a quantity of coordinate transformation modules 1041 in the coordinate transformation circuit 104 equals a quantity of detection channels of the LiDAR 10 and corresponds to them one-to-one, ensuring that the scanning coordinates collected by each detection channel can be correctly transformed and processed by the corresponding coordinate transformation module 1041, and improving the accuracy of the coordinate transformation.

In an embodiment, a quantity of coordinate transformation modules 1041 in the coordinate transformation circuit 104 is greater than a quantity of detection channels of the LiDAR 10. A detection channel of the LiDAR 10 can correspond to multiple coordinate transformation modules 1041, allowing multiple coordinate transformation modules 1041 to simultaneously perform coordinate transformation on the scanning coordinates of different detection points output by the detection channel, effectively improving the efficiency of coordinate transformation for multiple detection points of the detection channel. When some of the coordinate transformation modules 1041 corresponding to the detection channel fail, the other coordinate transformation modules 1041 can still continue to perform coordinate transformation on the detection points of the detection channel, enhancing the fault tolerance of the coordinate transformation circuit 104.

A quantity of detection channels of the LiDAR 10 depends on a quantity of transceiver modules 1011, and a quantity of detection channels corresponds one-to-one with a quantity of transceiver modules 1011.

In an embodiment, a quantity of detection channels of the LiDAR 10 can be one or multiple. A single detection channel LiDAR 10 can provide basic distance measurement capability, with a simple structure and high reliability. A multi-detection channel LiDAR 10 can simultaneously acquire data from multiple angles, increasing the field of view of the LiDAR 10 for the target object. By coordinating multiple detection channels, measurement errors in a single detection channel can be eliminated or reduced, improving the resolution and accuracy of the LiDAR 10.

The control module 10411 is connected to the optical detection module 101, and the data processing module 10412 is connected to the control module 10411. The optical detection module 101 is used to obtain the scanning coordinates and detection distance of the detection point during operation.

In the case where the coordinate transformation circuit 104 includes multiple coordinate transformation modules 1041, the structures of the multiple coordinate transformation modules 1041 are the same. For any coordinate transformation module 1041 in the multiple coordinate transformation modules 1041, the input end of the coordinate transformation module 1041 is connected to the optical detection module 101 through the signal processing device 103 and the analog front end 102, allowing the echo signal output by the optical detection module 101 to be processed by the analog front end 102 and the signal processing device 103, obtaining the scanning coordinates and detection distance corresponding to the echo signal, and inputting the scanning coordinates and detection distance corresponding to the echo signal to the coordinate transformation circuit 104.

The field of view formed by the LiDAR 10 for detecting the target object is the target field of view, which refers to the spatial range that the LiDAR 10 can detect. When the LiDAR 10 is in operation, it emits an emitting laser beam at a high frequency and uses the scanning device to scan the emitting laser beam. When the emitting laser beam contacts the target object, the LiDAR 10 receives the echo signal corresponding to the emitting laser beam reflected from the target object, a detection result is obtained. The detection result includes the distance value, horizontal coordinate, and vertical coordinate calculated from the echo signal. Based on the distance value, horizontal coordinate, and vertical coordinate, the detection result can be represented as a detection point in the target field of view.

The control module 10411 is used to receive the operation trigger signal, and the scanning coordinates and detection distance of the detection point sent by the optical detection module 101. When the operation trigger signal is received, the control module 10411 sends the scanning coordinates and detection distance to the data processing module 10412 and controls the data processing module 10412 to determine the radar coordinates of the detection point based on the scanning coordinates and detection distance.

Before the scanning coordinates and detection distance of multiple detection points of multiple detection channels of the LiDAR 10 are input to the coordinate transformation circuit 104, the scanning coordinates and detection distance of multiple detection points are pre-stored in the third memory of the LiDAR 10. The LiDAR 10 also includes a superior monitoring module 105, and the control modules 10411 of the multiple coordinate transformation modules 1041 are respectively connected to the superior monitoring module 105. The superior monitoring module 105 is used to monitor the working status of each coordinate transformation module 1041 among the multiple coordinate transformation modules 1041, and the working status of each coordinate transformation module 1041 includes an idle state and a busy state. When the superior monitoring module 105 detects that a coordinate transformation module 1041 is in an idle state, the superior monitoring module 105 sends an operation trigger signal to the control module 10411 of the coordinate transformation module 1041, allowing the control module 10411 to read the scanning coordinates and detection distance of the detection point of the corresponding detection channel from the third memory, and to start the coordinate transformation operation.

For any coordinate transformation module 1041 among the multiple coordinate transformation modules 1041, the coordinate transformation module 1041 corresponds to one detection channel of the multiple detection channels of the LiDAR 10, and the control module 10411 of the coordinate transformation module 1041 receives the scanning coordinates and detection distance of the detection point detected by the corresponding detection channel. Each coordinate transformation module 1041 independently handles the coordinate transformation of one detection point of one detection channel, without waiting for data from other detection channels, thereby improving the efficiency and response speed of coordinate transformation. The design and implementation of the coordinate transformation circuit are simplified, as each coordinate transformation module 1041 only needs to focus on the detection channel it is responsible for, reducing coupling and mutual influence among coordinate transformation modules 1041, effectively avoiding data confusion or misalignment, and ensuring the accuracy and reliability of coordinate transformation.

In an embodiment, after the control module 10411 of the coordinate transformation module 1041 receives the operation trigger signal sent by the superior monitoring module 105, the control module 10411 reads the scanning coordinates and detection distance of the detection point of the corresponding detection channel from the third memory and sends them to the data processing module 10412 of the coordinate transformation module 1041. The control module 10411 then controls the data processing module 10412 to perform coordinate transformation on the scanning coordinates, obtaining the radar coordinates of the detection point and returning them to the control module 10411. After receiving the radar coordinates of the detection point, the control module 10411 can send the radar coordinates of the detection point to the lower-level processing circuit for further processing or store the radar coordinates of the detection point in the fourth memory. The control module 10411 can send the radar coordinates of the detection point to the superior monitoring module 105.

In an embodiment, the coordinate transformation circuit includes multiple coordinate transformation modules, and a quantity of coordinate transformation modules is not less than a quantity of detection channels of the LiDAR. Each detection channel corresponds to at least one coordinate transformation module. For any coordinate transformation module, it includes a control module and a data processing module. The control module is connected to the optical detection module, and the data processing module is connected to the control module. The optical detection module is used to obtain the scanning coordinates and detection distance of the detection point of the detection channel corresponding to the coordinate transformation module during the operation of the LiDAR. The control module is used to receive the operation trigger signal and, upon receiving it, and to obtain the scanning coordinates and detection distance of the detection point of the corresponding detection channel and send them to the data processing module. The control module controls the data processing module to determine the radar coordinates of the detection point based on the scanning coordinates and detection distance. The coordinate transformation algorithm is embedded into the data processing module, converting the scanning coordinates of the detection point to radar coordinates through hardware modules, reducing the processing resource occupation of the processor and lowering the computational power requirements. Additionally, the coordinate transformation circuit can perform real-time conversion of the scanning coordinates of the detection point, obtaining the radar coordinates of the detection point, making the coordinate data received by subsequent modules or software the radar coordinates of the detection point directly, effectively avoiding point cloud output delay.

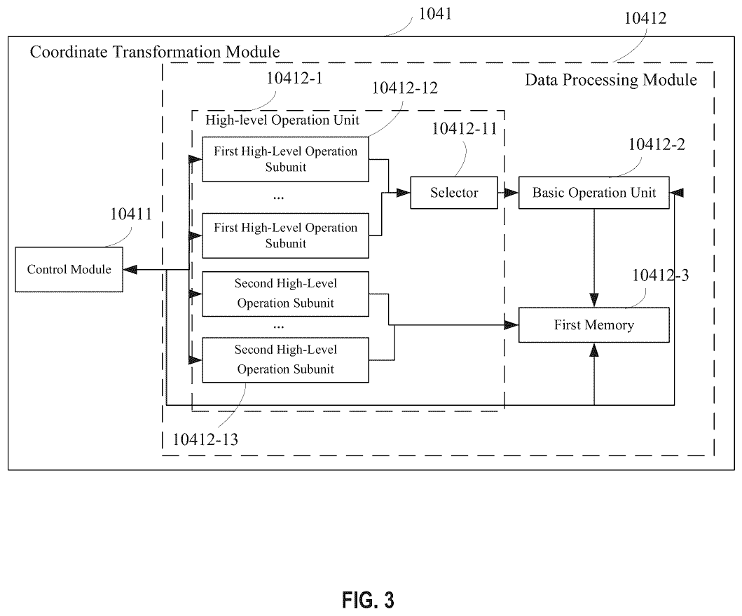

As shown in FIG. 3, FIG. 3 is a schematic circuit diagram of a coordinate transformation module provided by an embodiment. In an embodiment, the data processing module 10412 includes a high-level operation unit 10412-1, a basic operation unit 10412-2, and a first memory 10412-3.

The high-level operation unit 10412-1 is connected to the control module 10411, the basic operation unit 10412-2, and the first memory 10412-3. The basic operation unit 10412-2 is connected to the control module 10411 and the first memory, and the first memory is connected to the control module 10411. The control module 10411 controls the high-level operation unit 10412-1 to perform at least one of matrix multiplication, trigonometric function operation, complex number operation, exponentiation, square root operation, or logarithmic operation and controls the basic operation unit 10412-2 to perform addition operation and subtraction operation. The first memory is used to store intermediate value obtained by the high-level operation unit 10412-1 and the basic operation unit 10412-2.

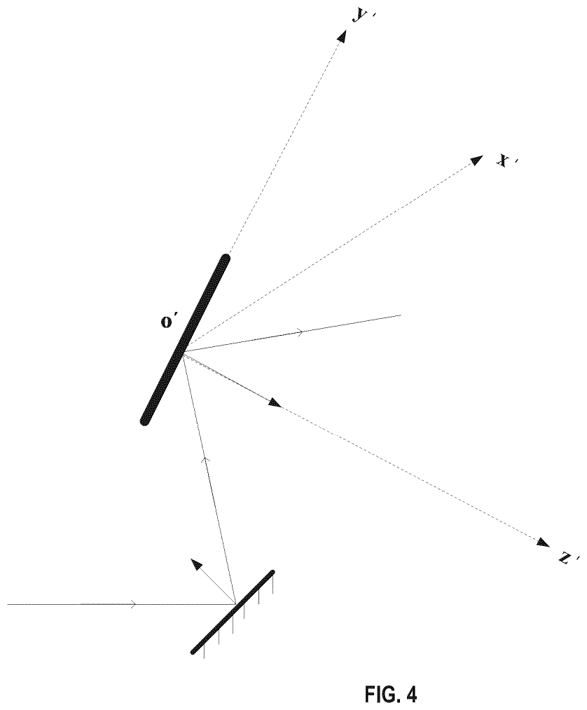

As shown in FIG. 4, FIG. 4 is a schematic diagram of a scanning coordinate system provided by an embodiment. At each moment during the operation of the LiDAR 10, the center of the scanning device is used as the origin o′, the normal vector of the scanning device is used as the z′ axis, the axis parallel to the working surface of the scanning device is used as the y′ axis, and the axis passing through the origin o′ and perpendicular to the yoz plane is used as the x′ axis, forming the scanning coordinate system o′-x′y′z′. During the operation of the LiDAR 10, the emitting vector and the incident vector are symmetrical about the normal vector of the scanning device. Since the normal vector of the scanning device is constantly changing, the scanning coordinate system o′-x′y′z′ is also constantly changing. Although the incident vector is fixed, the angle between the incident vector and the normal vector of the scanning device is constantly changing, causing the emitting vector to change with the scanning coordinate system o′-x′y′z′. Therefore, the scanning coordinates of different detection points belong to different scanning coordinate systems, making it hard to directly view and compare the data of different detection points.

In an embodiment, the scanning device is a galvanometer.

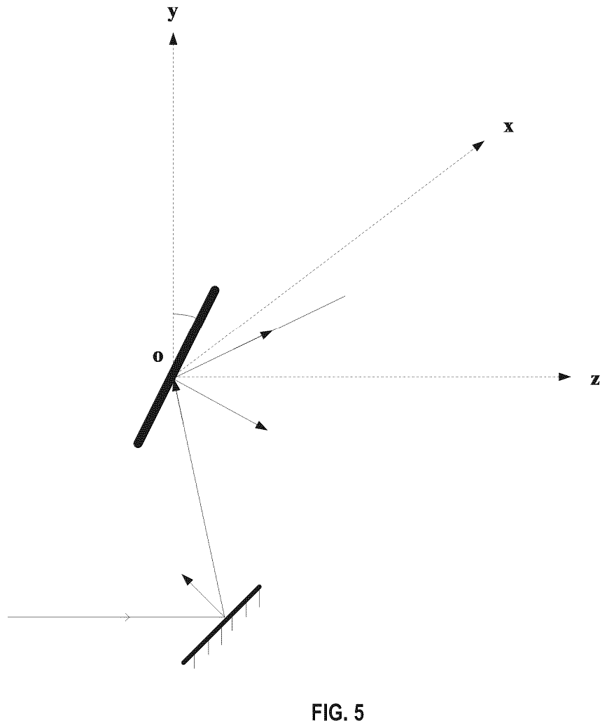

As shown in FIG. 5, FIG. 5 is a schematic diagram of a radar coordinate system provided by an embodiment. When the scanning device is stationary (the galvanometer is not powered on), the center of the scanning device is used as the origin o, the horizontal direction is used as the z axis, the vertical direction is used as the y axis, and the axis passing through the origin o and perpendicular to the yoz plane is used as the x axis, forming the radar coordinate system o-xyz. The radar coordinate system o-xyz remains unchanged, while the scanning coordinates of any detection point can be converted from the scanning coordinate system o′-x′y′z′ to the radar coordinate system o-xyz. Consequently, all scanning coordinates collected by the LiDAR 10 are converted into radar coordinates in the radar coordinate system o-xyz, facilitating the direct viewing and comparison of data from different detection points.

The method for converting the scanning coordinates of a detection point in the scanning coordinate system o′-x′y′z′ to radar coordinates in the radar coordinate system o-xyz is as follows: a first normal vector of the detection point in its corresponding scanning coordinate system o′-x′y′z′ and the second normal vector in the radar coordinate system o-xyz are known. The conversion relationship between the scanning coordinate system o′-x′y′z′ and the radar coordinate system o-xyz is obtained based on the relationship between the first normal vector and the second normal vector. The incident vector is known in the scanning coordinate system o′-x′y′z′. The initial emitting vector of the detection point is determined based on the incident vector and the first normal vector, and the scanning coordinates of the detection point in its corresponding scanning coordinate system o′-x′y′z′ are obtained based on the initial emitting vector of the detection point and the distance value of the detection point. Based on the scanning coordinates of the detection point and the conversion relationship between the scanning coordinate system o′-x′y′z′ and the radar coordinate system o-xyz, the radar coordinates of the detection point in the radar coordinate system o-xyz are obtained. The first normal vector is the normal vector of the scanning device in the scanning coordinate system o′-x′y′z′ of the detection point, and the second normal vector is the normal vector of the scanning device in the radar coordinate system o-xyz.

The normal vector of the scanning device refers to the vector represented by a straight line perpendicular to the plane where the scanning device is located. The incident vector refers to the propagation direction of the light incident on the scanning device. The emitting vector refers to the propagation direction of the light emitted from the surface of the scanning device after refraction, reflection, or transmission. The pitch angle (pitch) in the scanning coordinates describes the deflection angle of the detection point in the vertical direction of its corresponding scanning coordinate system, and the yaw angle (yaw) describes the deflection angle of the detection point in the horizontal direction of its corresponding scanning coordinate system. By combining the pitch angle and yaw angle, the rotation direction and attitude of the detection point in its corresponding scanning coordinate system can be described.

For a detection point, when converting the scanning coordinates of the detection point to radar coordinates, some high-level operations and basic operations are involved. The high-level operations include at least one of matrix multiplication, trigonometric function operation, complex number operation, exponentiation, square root operation, or logarithmic operation. The basic operations include addition and subtraction.

The high-level operation unit can perform one or more of matrix multiplication, trigonometric function operation, complex number operation, exponentiation, square root operation, or logarithmic operation.

In an embodiment, the data processing module includes a high-level operation unit, a basic operation unit, and a first memory. The high-level operation unit and the basic operation unit are connected to the control module, allowing the control module to control the high-level operation unit and the basic operation unit to perform corresponding operations. The high-level operation unit and the basic operation unit are connected to the first memory, which stores the intermediate results obtained by the high-level operation unit and the basic operation unit. Storing the intermediate results in the first memory reduces the data volume of input and output, effectively lowering the delay and throughput of the coordinate transformation circuit. The first memory can serve as a buffer between the high-level operation unit and the basic operation unit, simplifying the design and implementation of the data processing module and improving the maintainability and scalability of the coordinate transformation circuit. The high-level operation unit is more complex in structure than the basic operation unit. Connecting the high-level operation unit and the basic operation unit allows the basic operation unit to perform basic operations while the high-level operation unit extends these basic operations, enabling the data processing module to support more complex mathematical and logical operations, effectively improving computational efficiency and achieving more diverse computational operations. Additionally, connecting the high-level operation unit and the basic operation unit together can avoid repeated basic operations during complex computations, reducing the power consumption and chip area of the coordinate transformation circuit.

In an embodiment, the high-level operation unit performs matrix multiplication, trigonometric function operation, complex number operation, exponentiation, square root operation, or logarithmic operation, while the basic operation unit performs addition and subtraction. Connecting the basic operation unit to the high-level operation unit achieves the collaboration of basic and complex operations, meeting the computational requirements of coordinate transformation. Storing the intermediate values obtained by the high-level operation unit and the basic operation unit in the first memory avoids repeated calculations, allowing data sharing among multiple operations, further optimizing the coordinate transformation process. Additionally, based on the coordinate transformation requirements from scanning coordinates to radar coordinates, the control module can dynamically adjust the execution sequence of the high-level operation unit and the basic operation unit, maximizing the computational efficiency of the data processing module.

As shown in FIG. 3, in one embodiment, the high-level operation unit 10412-1 includes a selector 10412-11 and at least one first high-level operation subunit 10412-12. The first high-level operation subunit 10412-12 is connected to the control module 10411 and the selector. The selector is connected to the control module 10411 and the basic operation unit 10412-2. The first high-level operation subunit 10412-12 performs matrix multiplication on at least one of the scanning coordinates, detection distance, and intermediate values of the detection point, obtaining an operation result. The selector 10412-11 determines the target first high-level operation subunit among the at least one first high-level operation subunit based on the selection instruction from the control module 10411 and outputs the operation result of the target first high-level operation subunit.

The first high-level operation subunit performs matrix multiplication on at least one of the scanning coordinates, detection distance, and intermediate values of the detection point, obtaining an operation result. Different first high-level operation subunits perform matrix multiplication of different dimensions involved in coordinate transformation. Different dimensions of matrix multiplication involve different numbers of dimensions and parameters. Different first high-level operation subunits are set to perform these operations.

A quantity of first high-level operation subunits depends on a quantity of different dimensions of matrix multiplication involved in the scanning coordinates, detection distance, and intermediate values of the detection point. For example, a quantity of first high-level operation subunits can be three, where the first first high-level operation subunit performs 3×1 matrix multiplication, the second first high-level operation subunit performs 3×3 matrix multiplication, and the third first high-level operation subunit performs 2×2 matrix multiplication. By allocating different dimensions of matrix multiplication to different first high-level operation subunits, efficient coordinate transformation is achieved, allowing the high-level operation unit to flexibly handle data of different dimensions.

In an embodiment, the control module selects the corresponding first high-level operation subunit based on the current matrix multiplication required in the coordinate transformation process and uses the selector to select and output the operation result of the first high-level operation subunit called by the control module.

In an embodiment, based on the different dimensions of matrix multiplication involved in the scanning coordinates, detection distance, and intermediate values of the detection point, multiple first high-level operation subunits are configured, each used for performing matrix multiplication of different dimensions in the coordinate transformation process, ensuring precise calculation of matrix multiplication of different dimensions, thereby ensuring the accuracy of coordinate transformation. Each first high-level operation subunit has independent input and output, allowing for configuration based on the actual operation requirements in the coordinate transformation process to meet different coordinate transformation requirements. At the same time, since each first high-level operation subunit is responsible for handling operations of specific dimensions, a quantity of first high-level operation subunits can be flexibly increased or decreased as needed to meet coordinate transformation tasks of different scales or complexities.

As shown in FIG. 3, in an embodiment, the high-level operation unit 10412-1 also includes at least one second high-level operation subunit 10412-13. The second high-level operation subunit 10412-13 is connected to the control module 10411 and the first memory 10412-3. The second high-level operation subunit 10412-13 performs at least one of the trigonometric function operation, complex number operation, exponentiation, square root operation, or logarithmic operation on at least one of the scanning coordinates, detection distance, and intermediate values. Each second high-level operation subunit 10412-13 performs different operations.

The second high-level operation subunit performs at least one of the trigonometric function operation, complex number operation, exponentiation, square root operation, or logarithmic operation on at least one of the scanning coordinates, detection distance, and intermediate values. Different second high-level operation subunits perform different high-level operations in the coordinate transformation process.

A quantity of second high-level operation subunits depends on the types of high-level operations involved in the scanning coordinates, detection distance, and intermediate values in the coordinate transformation process. For example, in the coordinate transformation process, if the scanning coordinates, detection distance, and intermediate values only involve trigonometric function operations and complex number operations, a quantity of second high-level operation subunits can be set to two. One second high-level operation subunit performs trigonometric function operations on at least one of the scanning coordinates, detection distance, and intermediate values, and the other second high-level operation subunit performs complex number operations on at least one of the scanning coordinates, detection distance, and intermediate values. In another example, if the coordinate transformation process involves trigonometric function operations, complex number operations, exponentiation, square root operations, and logarithmic operations, a quantity of second high-level operation subunits can be set to five, where the five second high-level operation subunits respectively perform trigonometric function operations, complex number operations, exponentiation, square root operations, and logarithmic operations.

In an embodiment, based on the types of operations involved in the coordinate transformation process, multiple second high-level operation subunits are configured to perform different types of operations, meeting the diverse high-level operation requirements in the coordinate transformation process. Each second high-level operation subunit specifically performs a certain type of high-level operation, ensuring the accuracy and efficiency of calculations. Configuring multiple second high-level operation subunits provides diversified high-level operation support, achieving parallel computation acceleration and flexible configuration expansion to meet the various types of high-level operation requirements in the coordinate transformation process.

As shown in FIG. 2, in an embodiment, the coordinate transformation circuit 104 includes a second memory 1043. The second memory 1043 is connected to the control module 10411 and stores a look-up table. The look-up table includes pre-stored transformation parameters. The control module 10411 obtains the look-up table from the second memory 1043 and controls the execution of the high-level operation unit and the basic operation unit based on the transformation parameters in the look-up table.

Different scanning coordinate ranges correspond to different calculation matrices. The look-up table stores multiple sets of pre-defined transformation parameters, each set of transformation parameters corresponding to a different scanning coordinate range. When performing coordinate transformation on the scanning coordinates of a detection point, the specific steps are as follows. First, based on the scanning coordinates of the detection point, determine the scanning coordinate range to which the detection point belongs. Next, based on the scanning coordinate range of the detection point, find the set of transformation parameters corresponding to the scanning coordinate range in the look-up table. This set of transformation parameters includes matrix parameters for coordinate transformation within the scanning coordinate range. The set of transformation parameters is written into the first high-level operation unit, enabling the first high-level operation unit to perform matrix multiplication using the set of transformation parameters for the specific scanning coordinate range.

The scanning coordinate range is related to the area division rules of the target field of view. For example, in the case of dividing the target field of view into upper, middle, and lower areas based on the pitch value of the scanning coordinates, the upper, middle, and lower areas correspond to different scanning coordinate ranges. The scanning coordinate range of the upper area is pitch∈[A1˜A2), the scanning coordinate range of the middle area is pitch∈[A2˜A3), and the scanning coordinate range of the lower area is pitch∈[A3˜A4]. Each scanning coordinate range corresponds to a set of transformation parameters. In another example, in the case of dividing the target field of view into 2×2 areas based on the pitch value and yaw value of the scanning coordinates, the scanning coordinate range of the upper-left area is pitch∈[B1˜B2) and yaw∈[C1˜C2), the scanning coordinate range of the upper-right area is pitch∈[B1˜B2) and yaw∈[C2˜C3], the scanning coordinate range of the lower-left area is pitch∈[B2˜B3] and yaw∈[C1˜C2), and the scanning coordinate range of the lower-right area is pitch∈[B2˜B3] and yaw∈[C2˜C3]. Each scanning coordinate range corresponds to a set of transformation parameters, which may be the same or different for different scanning coordinate ranges.

Based on the scanning coordinates of the detection point, determine the scanning coordinate range to which the detection point belongs. The determination requires combining the area division of the target field of view and the scanning coordinates of the detection point to determine the scanning coordinate range to which the detection point belongs.

In an embodiment, the coordinate transformation circuit includes a second memory that stores a look-up table containing pre-stored transformation parameters. The control module can obtain the look-up table from the second memory, and control the execution of the high-level operation unit and the basic operation unit based on the transformation parameters in the look-up table, allowing the coordinate transformation circuit to dynamically select suitable transformation parameters based on the scanning coordinate range of the detection point. This effectively improves the accuracy and efficiency of coordinate transformation and allows for updating and configuring the transformation parameters based on the coordinate transformation requirements, adapting to different scanning coordinate ranges and requirements, and having a wide range of applications.

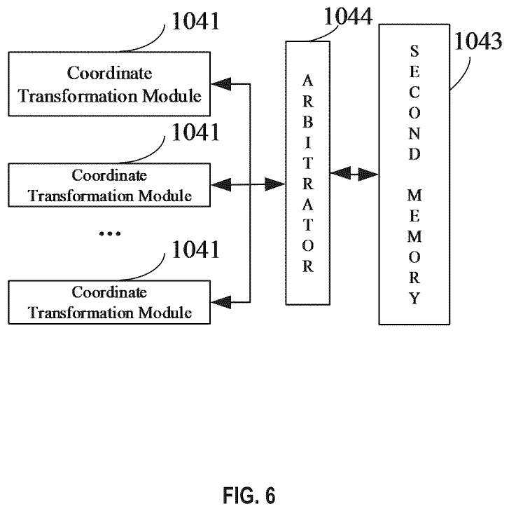

As shown in FIG. 6, FIG. 6 is a schematic circuit diagram of the coordinate transformation module, arbitrator, and second memory provided by an embodiment. In an embodiment, when a quantity of coordinate transformation modules is multiple, the coordinate transformation circuit 104 includes an arbitrator 1044. The arbitrator 1044 is connected to the control module 10411 of each coordinate transformation module 1041 and to the second memory 1043. When at least two control modules 10411 of the coordinate transformation modules 1041 simultaneously request to obtain the look-up table, the arbitrator 1044 is used to prioritize the requests from at least two coordinate transformation modules 1041.

When the LiDAR 10 has multiple detection channels, a quantity of coordinate transformation modules is also multiple, and a quantity of multiple coordinate transformation modules is equal to and corresponds one-to-one with a quantity of multiple detection channels.

The arbitrator is used to receive the requests from the control modules of multiple coordinate transformation modules and determine the priority of each request based on a priority decision algorithm. The arbitrator coordinates the access conflicts between different coordinate transformation modules, ensuring that each coordinate transformation module can access the look-up table in the second memory in the correct order.

The arbitrator uses a priority decision algorithm to determine the priority order of each request. The priority decision algorithm can be defined based on various factors. For example, the priority decision algorithm can be defined based on the position of the field of view corresponding to the detection channel within the target field of view. The detection channel corresponding to the field of view located in the middle position of the target field of view has the highest priority. The detection channel corresponding to the field of view located on both sides of the target field of view has a lower priority than the detection channel corresponding to the field of view located in the middle position of the target field of view. The priority decision algorithm can also be defined based on the difference between the yaw value of the scanning coordinates of the detection point and the preset angle. The detection channel with the yaw value of the scanning coordinates of the detection point being less than the preset angle has the highest priority. The detection channel with the yaw value of the scanning coordinates of the detection point being greater than or equal to the preset angle has a lower priority than the detection channel with the yaw value of the scanning coordinates of the detection point being less than the preset angle.

In this application embodiment, when a quantity of coordinate transformation modules is multiple, introducing an arbitrator to handle the request conflicts of multiple coordinate transformation modules ensures the stability and reliability of the coordinate transformation circuit during concurrent access in multi-tasking scenarios. The priority decision algorithm of the arbitrator can be designed to meet the flexible requirements for the request order in different application scenarios.

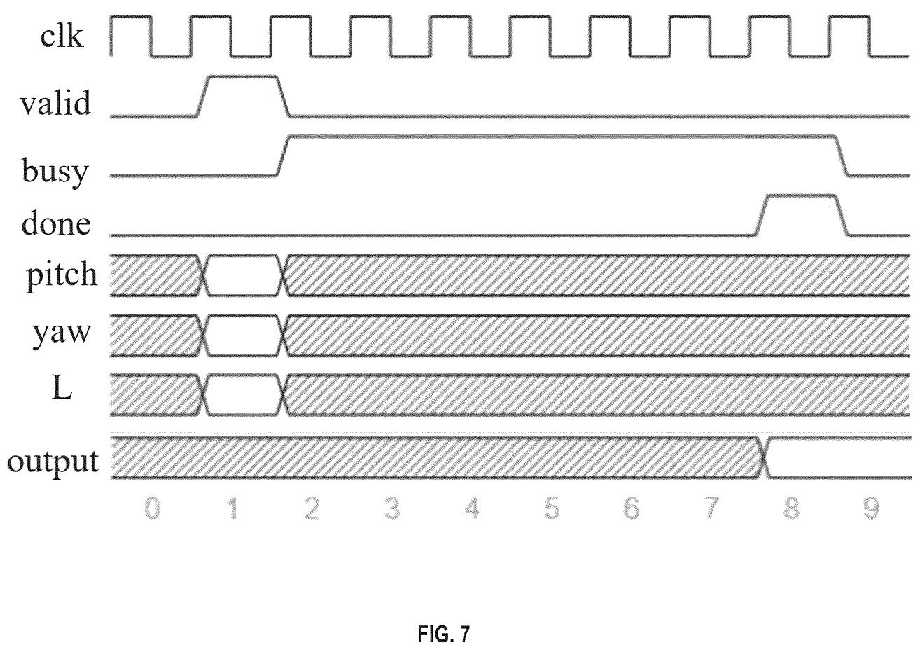

As shown in FIG. 7, FIG. 7 is an interaction timing diagram of the internal coordinate transformation module provided by an embodiment. For any coordinate transformation module among the multiple coordinate transformation modules, when the control module of the coordinate transformation module receives the operation trigger signal valid=1 sent by the superior monitoring module, the control module reads the scanning coordinates (pitch, yaw) and detection distance L of the detection point of the corresponding detection channel from the third memory. The pitch value and yaw value of the scanning coordinates and the detection distance L of the detection point are valid. After the control module receives the operation trigger signal valid=1, the coordinate transformation module changes from the idle state to the busy state (busy=1). The control module controls the data processing module to perform coordinate transformation on the scanning coordinates based on the received pitch value and yaw value of the scanning coordinates and the detection distance L of the detection point. At this time, the pitch value and yaw value of the scanning coordinates and the detection distance L of the detection point are invalid. When the coordinate transformation module completes the coordinate transformation of the detection point, the coordinate transformation module outputs a calculation end (done=1) signal and outputs the calculation result (output valid).

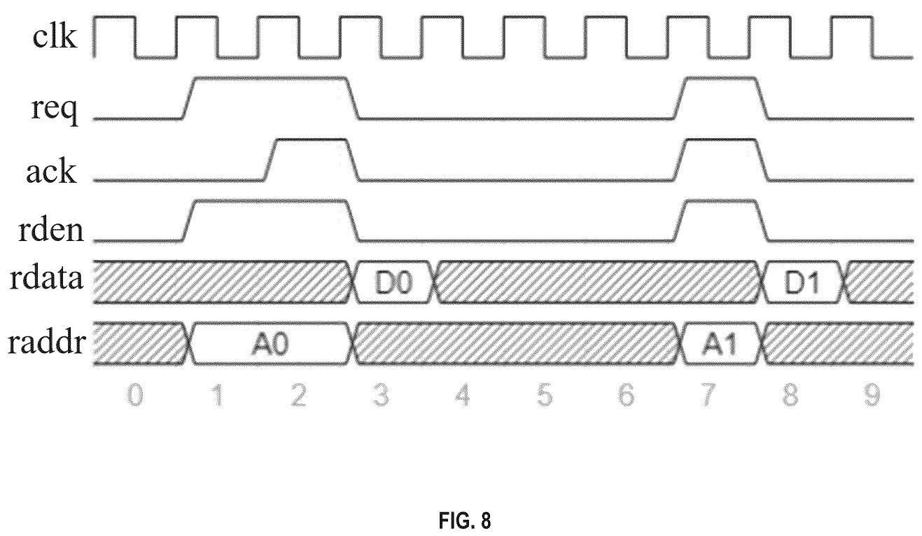

As shown in FIG. 8, FIG. 8 is a request-response timing diagram of the arbitrator for multiple coordinate transformation modules provided by an embodiment. Req represents a request, ack represents an acknowledgment, rden represents a read enable, raddr represents the address for reading the look-up table, and rdata represents the transformation parameters read from the look-up table. When multiple coordinate transformation modules simultaneously request to obtain the look-up table, the coordinate transformation module initiates a request to obtain the look-up table (req=1). The arbitrator makes a priority decision on the requests to obtain the look-up table from multiple coordinate transformation modules based on the priority decision algorithm and responds to the coordinate transformation module that gains the occupancy right (ack=1). At the same time, the arbitrator does not respond to the coordinate transformation modules that do not gain the occupancy right (ack=0). The coordinate transformation modules that do not gain the occupancy right maintain their requests until they receive a response. After the coordinate transformation module gains the occupancy right and receives a response (ack=1), the coordinate transformation module reads the transformation parameters required by the coordinate transformation module from the look-up table.

As shown in FIG. 8, for coordinate transformation module among the multiple coordinate transformation modules, when the coordinate transformation module first initiates a request to obtain the look-up table (req=1), there are other coordinate transformation modules simultaneously initiating requests to obtain the look-up table (req=1), and the priorities of the other coordinate transformation modules are higher than that of the coordinate transformation module. Therefore, in the first clock cycle when the coordinate transformation module first initiates the request to obtain the look-up table (req=1), the coordinate transformation module does not gain the occupancy right, and the arbitrator does not respond to the coordinate transformation module (ack=0). In the second clock cycle when the coordinate transformation module first initiates the request to obtain the look-up table (req=1), the coordinate transformation module gains the occupancy right, and the arbitrator responds to the coordinate transformation module (ack=1), allowing the coordinate transformation module to read the transformation parameters (D1 valid) required by the coordinate transformation module from the look-up table. When the coordinate transformation module initiates a request to obtain the look-up table (req=1) for the second time, there may be no other coordinate transformation modules simultaneously initiating requests to obtain the look-up table, or there may be other coordinate transformation modules simultaneously initiating requests to obtain the look-up table (req=1), but the priorities of the other coordinate transformation modules are lower than that of the coordinate transformation module. Therefore, after the coordinate transformation module initiates the request to obtain the look-up table (req=1) for the second time, the arbitrator directly responds to the coordinate transformation module (ack=1), allowing the coordinate transformation module to read the transformation parameters (D0 valid) required by the coordinate transformation module from the look-up table.

In an embodiment, the superior monitoring module is used to poll or query the coordinate transformation modules within a preset time interval to obtain the working status of the coordinate transformation modules. By monitoring the status information of the coordinate transformation modules, the superior monitoring module can timely detect faults or other abnormal situations in the coordinate transformation modules. When a coordinate transformation module fails, the superior monitoring module can take corresponding fault-tolerant measures to improve the reliability of the coordinate transformation module.

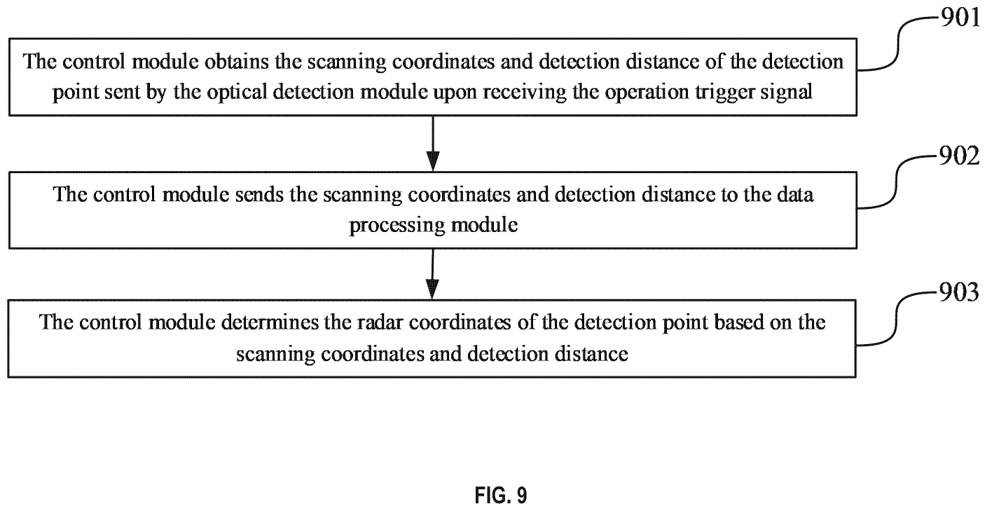

As shown in FIG. 9, FIG. 9 is a schematic flow chart of a coordinate transformation method provided by an embodiment. Taking the control module of any coordinate transformation module among the coordinate transformation circuit as the execution subject, the coordinate transformation method 900 includes steps 901 to 903.
Step 901: The control module obtains the scanning coordinates and detection distance of the detection point sent by the optical detection module upon receiving the operation trigger signal.
Step 902: The control module sends the scanning coordinates and detection distance to the data processing module.
Step 903: The control module determines the radar coordinates of the detection point based on the scanning coordinates and detection distance.

In an embodiment, the control module of the coordinate transformation module waits to receive the operation trigger signal sent by the superior monitoring module and, upon receiving the operation trigger signal, obtains the scanning coordinates and detection distance of the detection point of the corresponding detection channel pre-stored in the third memory by the optical detection module. The control module sends the scanning coordinates and detection distance of the detection point to the data processing module of the coordinate transformation module. The control module controls the data processing module to perform coordinate transformation on the scanning coordinates of the detection point based on the scanning coordinates and detection distance, obtaining the radar coordinates of the detection point. The coordinate transformation method can promptly obtain the scanning coordinates and detection distance of the detection point upon receiving the operation trigger signal and control the coordinate transformation module to perform coordinate transformation calculations on the scanning coordinates of the detection point, ultimately obtaining the radar coordinates of the detection point. The accuracy and real-time performance of the coordinate transformation method are good, providing valuable information for further data processing and application.

In an embodiment, step 903, the control module determines the radar coordinates of the detection point based on the scanning coordinates and detection distance, including steps 9032 and 9033.
Step 9032: The control module performs a trigonometric function operation on the scanning coordinates, obtaining the trigonometric function value corresponding to the scanning coordinates.

The control module controls the second high-level operation subunit in the high-level operation unit of the data processing module to perform a trigonometric function operation on the scanning coordinates, obtaining the trigonometric function value corresponding to the scanning coordinates and storing the trigonometric function value in the first memory for subsequent use.
Step 9033: The control module determines the radar coordinates of the detection point based on the scanning coordinates, trigonometric function value, and detection distance.

The control module determines the radar coordinates of the detection point based on the scanning coordinates, trigonometric function value, and detection distance, controlling the high-level operation unit and the basic operation unit of the data processing module to perform at least one of matrix multiplication, trigonometric function operation, complex number operation, exponentiation, square root operation, logarithmic operation, addition, and subtraction on the scanning coordinates, trigonometric function value, and detection distance to obtain the radar coordinates of the detection point.

In an embodiment, the control module first performs a trigonometric function operation on the scanning coordinates, obtaining the trigonometric function value corresponding to the scanning coordinates. Then, based on the scanning coordinates, trigonometric function value, and detection distance, the control module determines the radar coordinates of the detection point, achieving efficient coordinate transformation from the scanning coordinate system to the radar coordinate system.

In an embodiment, before step 9032, the control module performs a trigonometric function operation on the scanning coordinates, obtaining the trigonometric function value corresponding to the scanning coordinates. Step 903 further includes step 9031: Correcting the scanning coordinates to obtain the corrected scanning coordinates.

After obtaining the corrected scanning coordinates, in subsequent steps 9032 and 9033, the control module performs a trigonometric function operation on the corrected scanning coordinates, obtaining the trigonometric function value corresponding to the corrected scanning coordinates. Based on the corrected scanning coordinates, the trigonometric function value of the corrected scanning coordinates, and the detection distance, the control module determines the radar coordinates of the detection point.

In an embodiment, by correcting the scanning coordinates, errors caused by galvanometer installation errors or environmental factors can be eliminated or reduced. The corrected scanning coordinates are more accurate, improving the precision of the scanning coordinates. Correcting the scanning coordinates can identify and correct potential deviations or distortions in the scanning coordinates, reducing data uncertainty and making the data more reliable.

In an embodiment, step 9033, the control module determines the radar coordinates of the detection point based on the scanning coordinates, trigonometric function value, and detection distance, specifically including steps 90331 and 90332.
Step 90331: Obtaining the look-up table, which includes pre-stored transformation parameters.
Step 90332: Determining the radar coordinates of the detection point based on the transformation parameters, scanning coordinates, trigonometric function value, and detection distance.

In an embodiment, in the process of determining the radar coordinates of the detection point based on the scanning coordinates, trigonometric function value, and detection distance, the steps are as follows: based on the scanning coordinates of the detection point, determine the scanning coordinate range to which the detection point belongs. Based on the scanning coordinate range of the detection point, find the set of transformation parameters corresponding to the scanning coordinate range in the look-up table. The set of transformation parameters is written into the first high-level operation unit, enabling the first high-level operation unit, the second high-level operation unit, and the basic operation unit to perform operations on the scanning coordinates, trigonometric function value, and detection distance, obtaining the radar coordinates of the detection point.

What is claimed is:

1. A coordinate transformation circuit, comprising at least one coordinate transformation module, wherein the coordinate transformation module comprises a control module and a data processing module;
wherein the control module is connected to an optical detection module, the data processing module is connected to the control module, and the optical detection module is used to obtain a scanning coordinate of a detection point and a detection distance during operation;
wherein the control module is used to receive an operation trigger signal, and the scanning coordinate of the detection point and the detection distance sent by the optical detection module; and
wherein, when the control module receives the operation trigger signal, the control module sends the scanning coordinate and the detection distance to the data processing module, and controls the data processing module to determine a radar coordinate of the detection point based on the scanning coordinate and the detection distance.

2. The coordinate transformation circuit according to claim 1, wherein the data processing module comprises a high-level operation unit, a basic operation unit, and a first memory;
wherein the high-level operation unit is respectively connected to the control module, the basic operation unit, and the first memory, the basic operation unit is connected to the control module and the first memory, and the first memory is connected to the control module;
the control module controls the high-level operation unit to perform at least one of matrix multiplication, trigonometric function operation, complex number operation, exponentiation, square root operation, or logarithmic operation, and the control module controls the basic operation unit to perform addition operation and subtraction operation; and
the first memory is used to store an intermediate value obtained by the high-level operation unit and the basic operation unit.

3. The coordinate transformation circuit according to claim 2, wherein the high-level operation unit comprises a selector and at least one first high-level operation subunit;
wherein the first high-level operation subunit is connected to the control module and the selector, the selector is connected to the control module and the basic operation unit;
wherein the first high-level operation subunit is used to perform matrix multiplication on at least one of the scanning coordinate of the detection point, the detection distance, or the intermediate value, to obtain an operation result; and
wherein the selector is used to determine a target first high-level operation subunit in the at least one first high-level operation subunit, and output the operation result of the target first high-level operation subunit, based on a selection instruction from the control module.

4. The coordinate transformation circuit according to claim 2, wherein the high-level operation unit further comprises at least one second high-level operation subunit;
wherein the second high-level operation subunit is connected to the control module and the first memory; and
wherein the second high-level operation subunit is used to perform at least one of the trigonometric function operation, the complex number operation, the exponentiation, the square root operation, or the logarithmic operation on the scanning coordinate of the detection point, the detection distance, and the intermediate value, and each second high-level operation subunit performs different operations.

5. The coordinate transformation circuit according to claim 2, further comprising a second memory, wherein the second memory is connected to the control module, the second memory stores a look-up table, and the look-up table comprises a prestored transformation parameter; and
wherein the control module obtains the look-up table from the second memory, and controls the high-level operation unit and the basic operation unit based on the transformation parameter in the look-up table.

6. The coordinate transformation circuit according to claim 5, wherein, when there are a plurality of coordinate transformation modules, the coordinate transformation circuit further comprises an arbitrator;
wherein the arbitrator is connected to the control module of each coordinate transformation module, and the arbitrator is also connected to the second memory; and
wherein, when the control modules of at least two coordinate transformation modules simultaneously request to obtain the look-up table, the arbitrator is used to make a priority decision on acquisition requests of the at least two coordinate transformation modules.

7. A coordinate transformation method, used for the coordinate transformation circuit according to claim 1, the method comprising:
receiving an operation trigger signal, and obtaining a scanning coordinate of a detection point and a detection distance;
sending the scanning coordinate and the detection distance to a data processing module; and
determining a radar coordinate of the detection point based on the scanning coordinate and the detection distance.

8. The method according to claim 7, wherein the determining a radar coordinate of the detection point based on the scanning coordinate and the detection distance comprises:
performing a trigonometric function operation on the scanning coordinate, to obtain a trigonometric function value corresponding to the scanning coordinate; and
determining a radar coordinate of the detection point based on the scanning coordinate, the trigonometric function value, and the detection distance.

9. The method according to claim 8, wherein before the performing a trigonometric function operation on the scanning coordinate to obtain a trigonometric function value corresponding to the scanning coordinate, the method further comprises:
performing a correction on the scanning coordinate to obtain a corrected scanning coordinate.

10. The method according to claim 8, wherein the determining the radar coordinate of the detection point based on the scanning coordinate, the trigonometric function value, and the detection distance comprises:
obtaining a look-up table, wherein the look-up table comprises a prestored transformation parameter; and
determining the radar coordinate of the detection point based on the transformation parameter, the scanning coordinate, the trigonometric function value, and the detection distance.
